(19) United States
(12) Patent Application Publication
(10) Pub. No.: US 2018/0079374 A1
(43) Pub. Date: Mar. 22, 2018

(54) VEHICLE BODY ATTACHMENT STRUCTURE FOR GROMMET

(71) Applicant: Sumitomo Wiring Systems, Ltd., Yokkaichi (JP)

(72) Inventors: Hirokazu NAKAI, Yokkaichi (JP); Yuki OOHIRA, Yokkaichi (JP)

(21) Appl. No.: 15/664,895

(22) Filed: Jul. 31, 2017

(30) Foreign Application Priority Data
Sep. 16, 2016 (JP) 2016-181440

(51) Int. Cl. B60R 16/02

(52) U.S. Cl. CPC B60R 16/0222

(57) ABSTRACT

A routing space for a wire harness is reduced in size and includes a body panel BP in which an attachment hole having an oval shape is formed; and a grommet that is formed using a rubber material. The grommet includes: a tube portion that is formed into a cylinder into which a wire harness WH can be inserted and passes through the attachment hole in an orientation of being inclined with respect to the body panel BP; and a body seal portion that is formed so as to protrude from an outer circumferential surface of the tube portion and conform to the body panel BP, and comes into contact watertightly with the vehicle body.

### CROSS REFERENCE TO RELATED APPLICATIONS

This application claims the priority of Japanese patent application JP2016-181440 filed on Sep. 16, 2016, the entire contents of which are incorporated herein.

### TECHNICAL FIELD

The present invention relates to a vehicle body attachment structure for a grommet.

### BACKGROUND ART

A grommet according to JP 2012-191822A is for passing a wire harness through a body panel in a sealed state. This grommet includes an elastically bendable harness insertion portion into which a wire harness is inserted, and a body seal portion that protrudes outward from the harness insertion portion and is elastically sealed to the periphery of an opening portion of an attachment hole in the body panel.

In the case of the above-described structure, the harness insertion portion is inserted through the attachment hole of the body panel along an axis. In other words, the harness insertion portion penetrates straight through the body panel in an orientation intersecting with the planar direction of the body panel. Accordingly, even if the wire harness is routed in a bent manner immediately after being passed through the harness insertion portion, the bent portion is inevitably separated from the body panel by a considerable degree. That is, since the wire harness is routed in a state of protruding from the body panel, there has been a problem in that the needed routing space increases by a corresponding amount.

### SUMMARY

The present design was achieved based on the above-described circumstance and it is an object thereof to provide a vehicle body attachment structure for a grommet, according to which the routing space in the periphery of the portion at which the wire harness passes through the body panel can be reduced in size.

The vehicle body attachment structure for a grommet according to the design includes: a body panel in which an attachment hole having an oval shape is formed; and a grommet that is formed using an elastic material and includes: a tube portion that is formed into a cylinder into which a wire harness can be inserted and passes through the attachment hole in an orientation of being inclined with respect to the body panel; and a body seal portion that is formed so as to protrude from an outer circumferential surface of the tube portion and conform to the body panel, and comes into contact watertightly with the vehicle body.

According to the present design, since the tube portion passes through the body panel in an inclined orientation, it is easy to bend the wire harness to the side conforming to the inclination direction immediately after passing through the body panel. Also, compared to the case of penetrating through the body panel in an upright orientation, the position of the bent portion of the wire harness can be set to a position closer to the body panel, and therefore it is possible to avoid a case in which the wire harness interferes with a peripheral member, which contributes to reducing the routing space for the wire harness.

### BRIEF DESCRIPTION OF THE DRAWINGS

FIG. 1 is a cross-sectional view showing a vehicle body attachment structure for a grommet according to an embodiment.

FIG. 2 is a partial enlarged view from a body seal portion side of a grommet.

FIG. 3 is a perspective view showing a bracket.

FIG. 4 is a perspective view showing a state in which the bracket is attached to the grommet.

FIG. 5 is a plan view showing an attachment hole in a body panel.

### EMBODIMENTS OF THE INVENTION

Preferred embodiments of the present design will be described hereinafter.

A bellows-shaped flexible portion may be formed on an intermediate portion of the tube portion. With this configuration, the flexible portion formed on the tube portion can be bent freely, and therefore the task of routing the wire harness can be performed easily.

It is preferable that a bracket for fixing the grommet to the body panel is further included, wherein a flange portion that is sealed in a watertight state to the body panel is formed on a base portion side of the body seal portion, a retainer portion is formed in a stepwise shape on a side of the flange portion opposite to the body panel, and a locking recess is formed in a recessed manner along the entire circumference of a boundary portion between the retainer portion and the flange portion, the bracket is formed by including a cover portion that covers an outer surface of the flange portion when the bracket is fit from one end side of the tube portion and is locked on the retainer portion, and an attachment portion that is formed so as to protrude outward from a circumferential edge of the cover portion and is to be attached to the body panel, and furthermore, cut-out recesses are provided at a plurality of locations on the outer circumferential portion of the retainer portion.

According to this kind of configuration, when the bracket is to be set in the body seal portion of the grommet, the cover portion of the bracket is fit thereon from one end of the tube portion. Also, the outer circumferential portion of the retainer portion is passed through the cover portion by being deformed so as to reduce its diameter, but at this time, cut-out recesses are provided at multiple locations in the outer circumferential portion of the retainer portion, and therefore it is possible to smoothly perform the task of the cover portion allowing the retainer portion to pass therethrough. Accordingly, the bracket can be set in the grommet in a state in which the cover portion is locked in the locking recess and covers the flange portion.

Also, it is possible to use a configuration in which index portions are provided on the bracket and the grommet and due to the index portions being aligned, positioning can be performed such that a state of being mutually attached is achieved.

According to this kind of configuration, by aligning the index portions, the bracket and the grommet can be attached correctly.

### Embodiment 1

Next, a specific embodiment will be described with reference to the drawings.

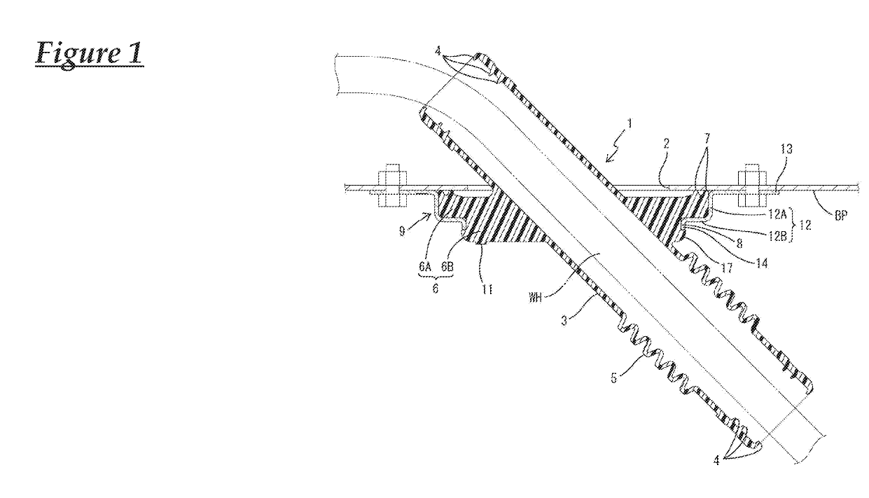

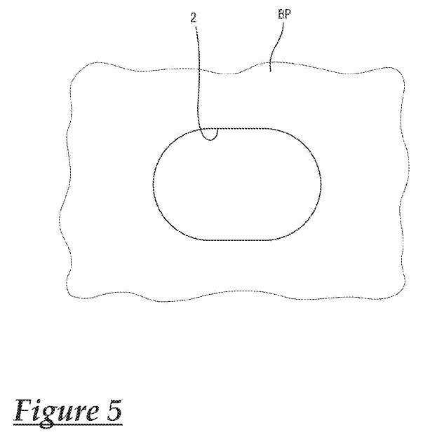

FIG. 1 shows a state in which a grommet 1 is attached to a body panel BP in a sealed state. The body panel BP of the present embodiment is a partitioning wall in an engine room in a hybrid vehicle or the like. Here, an attachment hole 2 for allowing the grommet 1 to pass through is provided. The attachment hole 2 is formed in an oval shape as shown in FIG. 5. The oval constituting the attachment hole 2 is such that the major axis is oriented in the left-right direction in FIG. 1, or in other words, a direction conforming to the inclination direction of a tube portion 3, as will be described later.

Note that in FIG. 1, the engine room side is below the illustration of the body panel BP and the outside of the vehicle is above the illustration of the body panel BP.

The grommet 1 is formed integrally using a rubber material. The grommet 1 is constituted by including the tube portion 3 for inserting a wire harness WH constituted by multiple wires, and a body seal portion 6 for ensuring a state of being sealed to the body panel BP.

The tube portion 3 is formed into a circular tube shape with a circular cross section, and as shown in FIG. 1, when the grommet 1 is attached to the body panel BP, it penetrates through the body panel BP in an inclined orientation. An end portion of a corrugated tube, for example, is fit into the end portion of the tube portion 3 on the engine room side, and an end portion of a shield pipe, for example, is fit into the end portion on the outside of the vehicle, although this is not illustrated in detail. In a state in which multiple seal lips 4 are formed over the entire circumference on the inner circumferential surface on both end portions of the tube portion 3 and the above-described corrugated tube and shield pipe are connected, the seal lips 4 are sealed in a state of being sealed with the outer circumferential surfaces of the corrugated tube and the shield pipe. Note that at this time, at portions of the outer circumferential surface of the tube portion 3 that correspond to the seal lips 4, fastening to the tube portion 3 is performed using metal crimping rings or cable ties, whereby the connection state is held.

A bellows-shaped flexible portion 5 is formed near the end portion on the engine room side of the tube portion 3. The flexible portion 5 can extend and contract in the length direction and is provided with a favorable bending ability. The body seal portion 6 is provided at an intermediate portion, or more specifically, between the flexible portion 5 and the vehicle outside end portion of the tube portion 3, and is formed so as to protrude in a direction along the planar direction of the body panel BP. The flange portion 6A, which is formed into a roughly oval shape, is formed on the base portion side (body panel BP side) of the body seal portion 6. Also, on a surface on the side opposite to the body panel BP of the flange portion 6A, a retainer portion 6B having an approximately oval shape that is one size smaller than the flange portion 6A is formed so as to be overlaid in the thickness direction of the flange portion 6A.

As shown in FIG. 1, the flange portion 6A is formed with an external shape that is sufficiently larger than the attachment hole 2 so that it can cover up the entirety of the attachment hole 2 of the body panel BP. Seal edges 7 are formed in ring shapes on the circumferential edge portion of the surface of the flange portion 6A facing the body panel BP. Two seal edges 7, namely an inner seal edge 7 and an outer seal edge 7, are provided on the opposing surface of the flange portion 6A, and each is provided in a protruding manner along the entire circumference of the flange portion 6A. In the state in which the grommet 1 is attached to the body panel BP, the seal edges 7 are elastically sealed to the periphery of the attachment hole 2 of the body panel BP, and thereby the gap between the grommet 1 and the body panel BP is kept in a watertight state.

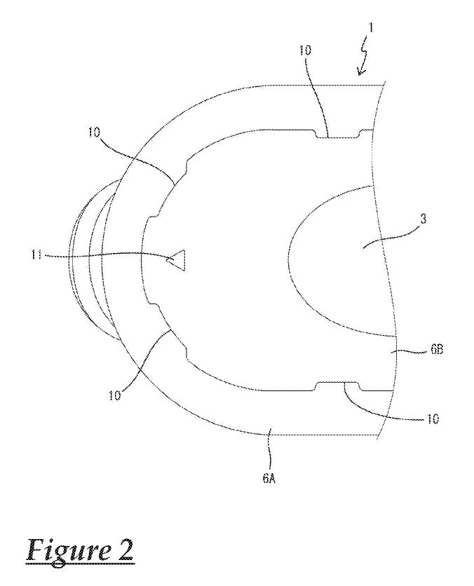

As shown in FIG. 1, the flange portion 6A is formed into a platform shape having a predetermined thickness, and the retainer portion 6B is formed so as to be overlaid approximately coaxially on the flange portion 6A. A locking recess 8 is formed recessed along the entire circumference of the outer circumferential surface on the border portion between the retainer portion 6B and the flange portion 6A. As shown in FIG. 1, the bracket 9 is locked in the locking recess 8 to retain the bracket 9. A rounded surface 17 is formed in an arc shape on the outer circumferential surface of the surface from which the tube portion 3 protrudes on the retainer portion 6B. Also, as shown in FIG. 2, cut-out recesses 10 are arranged at multiple locations on the outer circumferential surface of the retainer portion 6B. The cut-out recesses 10 are arranged at an appropriate interval along the circumferential direction of the retainer portion 6B, and are formed by being cut out in the entire thickness of the retainer portion 6B and in predetermined lengths in the circumferential direction.

The cut-out recesses 10 are thus provided on the outer circumferential portion of the retainer portion 6B in order to cause the retainer portion 6B to compress with a lighter force by lowering the rigidity of the retainer portion 6B due to the fact that when the bracket 9 is to be attached to the body shield portion 6, the locking tube 14 of the bracket 9 passes the retainer portion 6B while the retainer portion 6B is compressed in the circumferential direction.

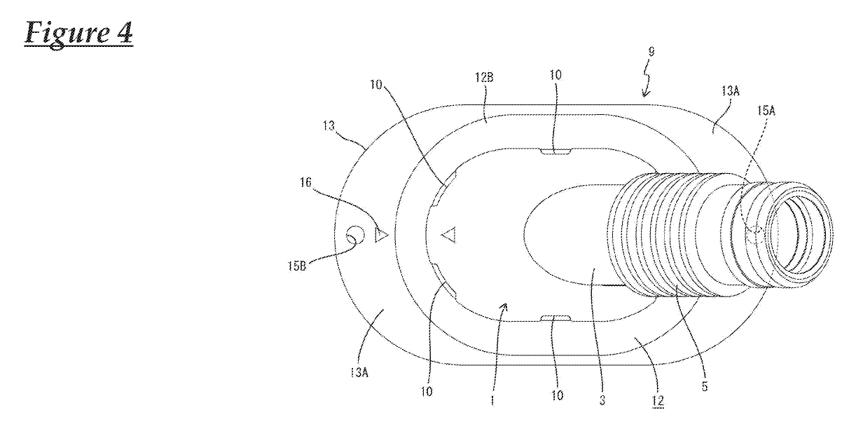

As shown in FIGS. 2 and 4, a grommet-side index portion 11 for indicating the attachment position of the bracket 9 is formed in a state of having a triangular shape and slightly protruding toward the outer surface, at a predetermined position on the end surface on the side of the retainer portion 6B opposite to the body panel BP.

The bracket 9 is formed using a plate material made of metal. With the bracket 9, a cover portion 12 into which the flange portion 6A is fit and that covers the outer surface of the flange portion 6A, and an attachment portion 13 that protrudes outward from the circumferential edge of the cover portion 12 and is for attaching to the body panel BP are formed integrally.

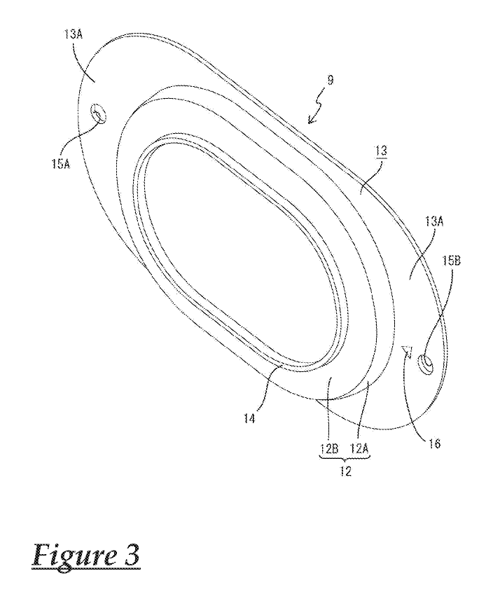

As shown in FIG. 1, the cover portion 12 is composed of a side wall portion 12A that is sealed along the circumferential surface of the flange portion 6A of the grommet 1, and an end surface portion 12B that is bent in an approximate right angle inward from the side wall portion 12A and is sealed to the end surface of the flange portion 6A on the side opposite to the seal edges 7. The flange portion 6A can be covered by the side wall portion 12A and the end surface portion 12B in a state of fitting together. As shown in FIG. 3, the end surface portion 12B has an opening formed in an oval shape through which the retainer portion 6B can pass.

The locking tube 14 is formed outward along the entire edge of the opening of the end surface portion 12B, standing at an approximate right angle. The locking tube 14 has an opening so that the retainer portion 6B can pass therethrough while compressed in the circumferential direction, and after the retainer portion 6B has passed therethrough, the locking tube 14 can fit into and be locked in the locking recess 8. Accordingly, the bracket 9 is attached in a state of being retained with respect to the grommet 1.

The attachment portion 13 of the bracket 9 is formed so as to protrude at an approximate right angle outward from the circumferential edge on the body panel BP side of the side wall portion 12A, and the entire surface thereof can be sealed to the body panel BP. As shown in FIGS. 3 and 4, a pair of extended portions 13A, which have small protrusion widths on the sides along the minor axis and protrude significantly on the sides along the major axis, are formed on the attachment portion 13. Screw holes 15A and 15B for performing fastening using screws onto the body panel BP are formed near the leading ends of the two extended portions 13A. Also, a bracket-side index portion 16 is formed on the extended portion 13A on the side on which one screw hole 15B is formed. The bracket-side index portion 16 is formed in a recessed manner by punching the surface of the elongated portion 13A into a triangular shape. If the bracket 9 is attached to the grommet 1, the vertices of the triangular shapes of the bracket-side and grommet-side index portions 11 and 16 can be attached in a positioned state by being made to oppose each other on the same line.

Next, effects of the present embodiment configured as described above will be described. As an example of a task of attaching the grommet 1 to the body panel BP, for example, the bracket 9 is fit onto the grommet 1 from the tube portion 3 on the side on which the flexible portion 5 is formed. At this time, the grommet-side and the bracket-side index portions 11 and 16 are aligned in advance. Then, the retainer portion 6B of the grommet 1 is passed through the locking tube 14 of the bracket 9 while compressed in the circumferential direction, but as described above, in this case, since the rigidity of the circumferential edge portion of the retainer portion 6B is lowered due to the multiple cut-out recesses 10 arranged on the circumferential edge of the retainer portion 6B, the retainer portion 6B can be passed through the locking tube 14 of the bracket 9 with a low operation force.

Thus, the cover portion 12 of the bracket 9 covers the flange portion 6A of the grommet 1 and the locking tube 14 is fit into the locking recess 8 and locked, and therefore the bracket 9 is attached to the grommet 1 in a regular state.

Thereafter, or prior thereto, the wire harness WH is inserted into the tube portion 3. Then, the tube portion 3 passes through to the attachment hole 2 of the body panel BP and the attachment portion 13 of the bracket 9 is sealed to the body panel BP. Also, the two screw holes 15A and 15B are in communication with the screw holes on the body panel BP side and fastening by screwing to the body panel BP is performed using nuts and bolts, and thereby the task of fixing the grommet 1 is complete.

With the wire harness WH relayed as described above, the tube portion 3 passes obliquely through the body panel BP, and therefore when the wire harness WH is bent immediately after penetrating through the tube portion 3, the bending portion can be set closer to the body panel BP compared to the case of passing straight through. Accordingly, the relaying space for the wire harness WH can be reduced by a corresponding amount, which is also effective for avoiding interference with peripheral members.

Also, in the present embodiment, the wire harness WH can be routed freely so as to form a bellows-shaped flexible portion 5 on the portion of the tube portion 3 of the grommet 1 that protrudes toward the engine room. Accordingly, it is particularly advantageous for use in an engine room with only a small routing space.

Furthermore, the index portions 11 and 16 are provided on the grommet side and the bracket side, and by causing them to coincide, it is possible to correctly attach the bracket 9 to the grommet 1.

### Other Embodiments

The present invention is not limited to the embodiment described above with reference to the drawings, and for example, the following embodiments are also encompassed in the technical scope of the present invention.

In the above-described embodiment, the bracket 9 is used to fix the grommet 1 to the body panel BP, but it is also possible to perform fixing using only the elastic reaction force of the grommet 1 without using the bracket 9.

In the above-described embodiment, a mode was shown in which the grommet 1 includes only one tube portion 3, but it is also possible to use a mode in which the grommet 1 includes multiple tube portions 3. In this case, tube portions 3 with different inclination directions may be included.

In the above-described embodiment, a case was indicated in which the flexible portion 5 is arranged only on the engine room side, but it may also be arranged on both sides.

In the above-described embodiment, a case was illustrated in which the tube portion 3 is loosely inserted into the attachment hole 2 of the body panel BP, but it may also be inserted in a state of having almost no gaps.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### REFERENCE SIGNS LIST

1 Grommet
2 Attachment hole
3 Tube portion
5 Flexible portion
6 Body seal portion
6A Flange portion
6B Retainer portion
9 Bracket
10 Cut-out recess
11 Grommet-side index portion
16 Bracket-side index portion
BP Body panel
WH Wire harness

1. A vehicle body attachment structure for a grommet, comprising:
a body panel in which an attachment hole having an oval shape is formed; and
a grommet that is formed using an elastic material and includes: a tube portion that is formed into a cylinder into which a wire harness can be inserted and passes through the attachment hole in an orientation of being inclined with respect to the body panel; and a body seal portion that is formed so as to protrude from an outer circumferential surface of the tube portion and conform to the body panel, and comes into contact watertightly with the vehicle body.

2. The vehicle body attachment structure for a grommet according to claim 1, wherein a bellows-shaped flexible portion is formed on an intermediate portion of the tube portion.

3. The vehicle body attachment structure for a grommet according to claim 1, further comprising:
a bracket for fixing the grommet to the body panel,
wherein a flange portion that is sealed in a watertight state to the body panel is formed on a base portion side of the body seal portion, a retainer portion is formed in a stepwise shape on a side of the flange portion opposite to the body panel, and a locking recess is formed in a recessed manner along the entire circumference of a boundary portion between the retainer portion and the flange portion,
the bracket is formed by including a cover portion that covers an outer surface of the flange portion when the bracket is fit from one end side of the tube portion and is locked on the retainer portion, and an attachment portion that is formed so as to protrude outward from a circumferential edge of the cover portion and is to be attached to the body panel, and
furthermore, cut-out recesses are provided at a plurality of locations on the outer circumferential portion of the retainer portion.

4. The vehicle body attachment structure for a grommet according to claim 3, wherein index portions are provided on the bracket and the grommet, and due to the index portions being aligned, positioning can be performed such that a state of being mutually attached is achieved.
